(19) United States
(12) Patent Application Publication
(10) Pub. No.: US 2009/0322171 A1
(43) Pub. Date: Dec. 31, 2009

(54) Motor bearing preload mechanism

(75) Inventors: Chia-Chun Wei, Taichung City (TW); Jin-Cheng Lin, Taichung City (TW)

Correspondence Address: CHARLES E. BAXLEY, ESQUIRE, 90 JOHN STREET, SUITE 309, NEW YORK, NY, 10038, US

(73) Assignee: Hiwin Mikrosystem Corp.

(21) Appl. No.: 12/215,346

(22) Filed: Jun. 26, 2008

(51) Int. Cl. H02K 5/16

(52) U.S. Cl. 310/90

(57) ABSTRACT

A motor bearing preload mechanism is a modulized object composed of a screw, a resilient pad and a connecting pad to be fixed in a motor housing of a motor so as to apply a pre-pressure to a motor shaft of the motor.

### BACKGROUND OF THE INVENTION

1. Technical Field

The present invention relates to motors, and more particularly, to a motor bearing preload mechanism applying a pre-pressure to a motor bearing so as to remedy or improve internal clearance of the motor bearing.

2. Description of Related Art

A motor bearing has been known as one of the critical factors that determine stability of a motor. Generally, a plurality of balls is settled in the bearing and circle inside a housing of the bearing when the bearing rotates. However, the conventional motor bearing tends to have internal clearance that impairs the operational efficiency of the motor and causes vibration, noise, heat and power waste during operation of the motor. Besides, as the balls vibrate in the housing of the bearing, a ball-contacting surface is subject to fretting wear. Thus, a pre-pressure has to be applied to the bearing so as to remedy or improve internal clearance of the bearing.

A conventional preload mechanism for a motor bearing, as shown in FIGS. 1 and 2, comprises a motor housing 10, a motor shaft 11 settled in the motor housing 10, a bearing 12 settled between the motor housing 10 and the motor shaft 11, a packing 13 arranged in the motor shaft 11, a positioning ring 14 deposited in the motor housing 10 and a preload mechanism 15 provided on the motor housing 10. The bearing 12 has an outer ring 121 connected with the motor housing 10, an inner ring 122 connected with the motor shaft 11 and a plurality of balls 123 settled between the inner ring 122 and the outer ring 121. The packing 13 abuts the inner ring 122 of the bearing 12 and the positioning ring 14 abuts the outer ring 121 of the bearing 12. The preload mechanism 15 includes a screw 151, and a spring 152 having an end connected with the screw 151 while having an opposite end connected with a metal pad 153. The preload mechanism 15 is screwed into a threaded hole 101 formed on the motor housing 10 so that the pad 153 abuts a shaft end 111 of the motor shaft 11 and presses against the spring 152, thereby a resilience of the spring 152 acting on the motor shaft 11. At this time, the packing 13 presses against the inner ring 122 of the bearing 12 along the motor shaft 11 so as to push the bearing 12 toward the positioning ring 14 and in turn make the positioning ring 14 press against the outer ring 121 of the bearing 12, thereby eliminating internal clearance among the inner ring 122, the outer ring 121 and the balls 123 of the bearing 12.

Though the prior art device accomplishes preload of the bearing 12 by using the preload mechanism 15, following drawbacks nevertheless happen in assembling and use of the aforementioned prior art device:

For performing particular resilience, the spring 152 must have a particular length and diameter, and, for accommodating such spring 152, the motor housing 10 must have a relatively large volume.

When the motor shaft 11 rotates, the spring coils of the spring 152 tend to shake and vertically impact the motor housing 10 and incur vibration and noise during operation of the motor.

While the motor shaft 11 and the connector 153 simply contact mutually without a fixed positioning point, when the motor shaft 11 has its worm 112 combined and operating with a worm gear to rotate, the worm 112 tends to be affected by a lateral pressure from the worm gear.

Additional assembling procedures and time are required by a wear-resistant material necessarily to be provided at the shaft end 111 of the motor shaft 11.

### SUMMARY OF THE INVENTION

One object of the present invention is to provide a motor bearing preload mechanism, which is a modulized object composed of a screw, a resilient pad and a connecting pad so that the motor bearing preload mechanism has a reduced volume thereby saving space the motor bearing preload mechanism takes in a motor housing and simplifying assembling procedures of the motor bearing preload mechanism.

Another object of the present invention is to provide a motor bearing preload mechanism, which is composed of a screw, a resilient pad and a connecting pad, wherein the resilient pad applies a pre-pressure to a motor bearing with its resilience so that when the motor shaft rotates, the bearing is secured from giving vibration and noise.

To achieve the above objectives of the present invention, the disclosed motor bearing preload mechanism comprises:

a main body, having a first end and a second end opposite mutually along an axis of the main body, and settled in a motor housing wherein the second end corresponds to a shaft end of a motor shaft in the motor housing;

an axial hole, preformed inside the main body and leading to the second end of the main body so as to provide an opening at the second end of the main body;

a resilient pad settled in the axial hole, having a first end abutting an extreme of the axial hole; and

a connecting pad, having a first end abutting a second end of the resilient pad so that the shaft end of the motor shaft presses against the connecting pad and receives a resilience from the resilient pad.

Another object of the present invention is to provide a motor bearing preload mechanism, which serves to support a shaft end of a motor shaft so as to enable the motor shaft to withstand a lateral pressure to a predetermined extent.

To achieve the above objective of the present invention, the disclosed motor bearing preload mechanism further comprises a supporting portion in the main body so as to support the shaft end of the motor shaft.

### BRIEF DESCRIPTION OF THE DRAWINGS

The invention as well as a preferred mode of use, further objectives and advantages thereof, will best be understood by reference to the following detailed description of an illustrative embodiment when read in conjunction with the accompanying drawings, wherein:

FIG. 1 is a disassembled sectional view of a conventional motor bearing preload mechanism and a motor;

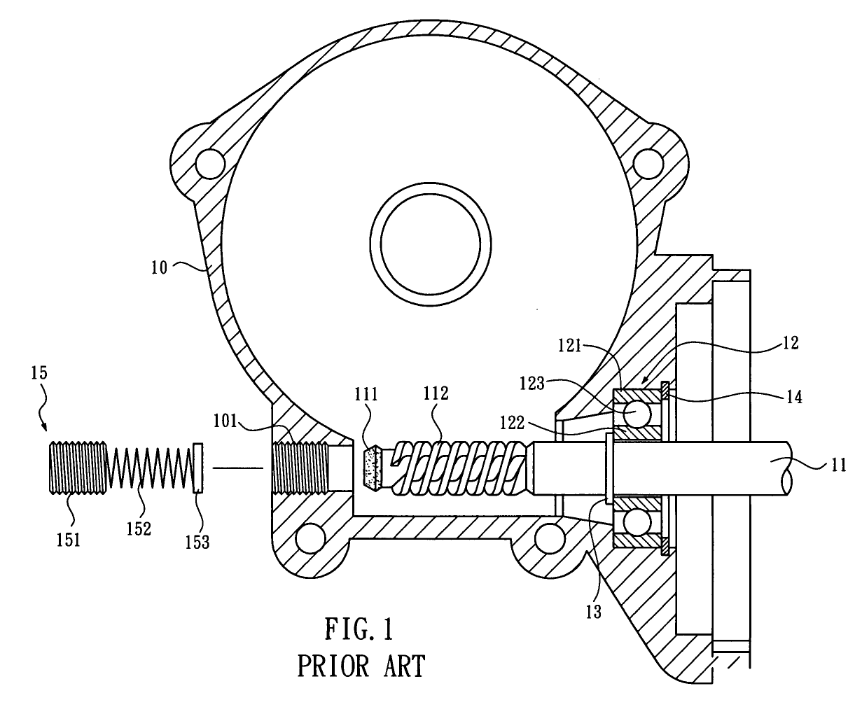

FIG. 2 is an assembled sectional view of the conventional motor bearing preload mechanism and the motor;

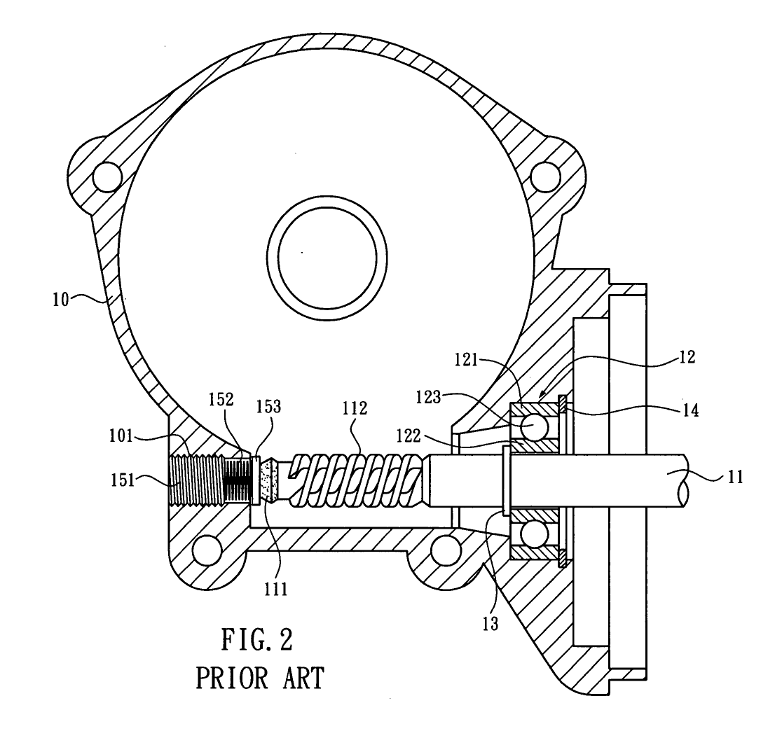

FIG. 3 is a disassembled sectional view of a motor bearing preload mechanism in a form of a set screw and a motor according to the present invention;

FIG. 4 is an assembled sectional view of the motor bearing preload mechanism in the form of a set screw and the motor according to the present invention;

FIG. 5 is an exploded sectional view of a motor bearing preload mechanism in a form of a raised head screw and a motor according to the present invention; and

FIG. 6 is an assembled sectional view of the motor bearing preload mechanism in the form of the raised head screw and the motor according to the present invention.

### DETAILED DESCRIPTION OF THE PREFERRED EMBODIMENT

While a preferred embodiment is provided herein for illustrating the concept of the present invention as described above, it is to be understood that the components in these drawings are made for better explanation and need not to be made in scale.

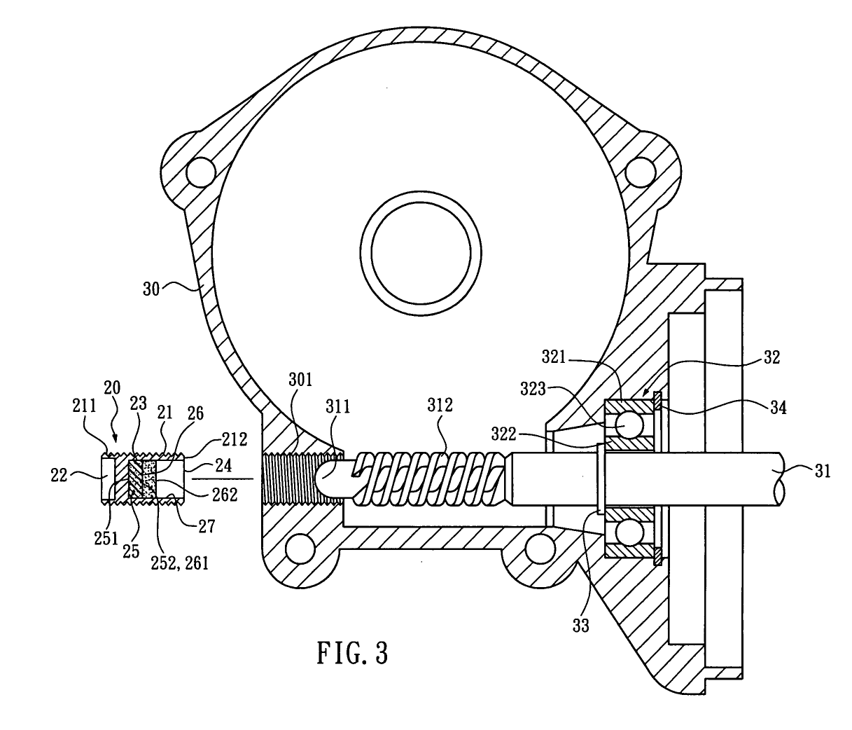

Referring to FIGS. 3 to 6, a motor bearing preload mechanism 20 of the present invention comprises a main body 21, an operational portion 22, an axial hole 23, a resilient pad 25, a connecting pad 26, and a supporting portion 27.

The main body 21 has a first end 211 and a second end 212 opposite mutually along an axis of the main body 21. Furthermore, the main body 21 is formed with external threads.

The operational portion 22 is formed at the first end 211 of the main body 21.

The axial hole 23 is preformed inside the main body 21 and leads to the second end 212 of the main body 21 so as to provide an opening 24 at the second end 212 of the main body 21.

The resilient pad 25 is put from the opening 24 and fixed in the axial hole 23. The resilient pad 25 has a first end 251 abutting an extreme of the axial hole 23. In the present embodiment, the resilient pad 25 is substantially a pad made of rubber.

The connecting pad 26 is also put from the opening 24 and fixed in the axial hole 23. The connecting pad 26 has a first end 261 abutting a second end 252 of the resilient pad 25. The connecting pad 26 may be integrally made of a wear-resistant material or coated by a wear-resistant material, or may have received a surface wear-resistant process, so as to be imparted with a wear-resistant characteristic.

The supporting portion 27 is formed by a peripheral wall of the axial hole 23 and adjacent to the second end 212 of the main body 21.

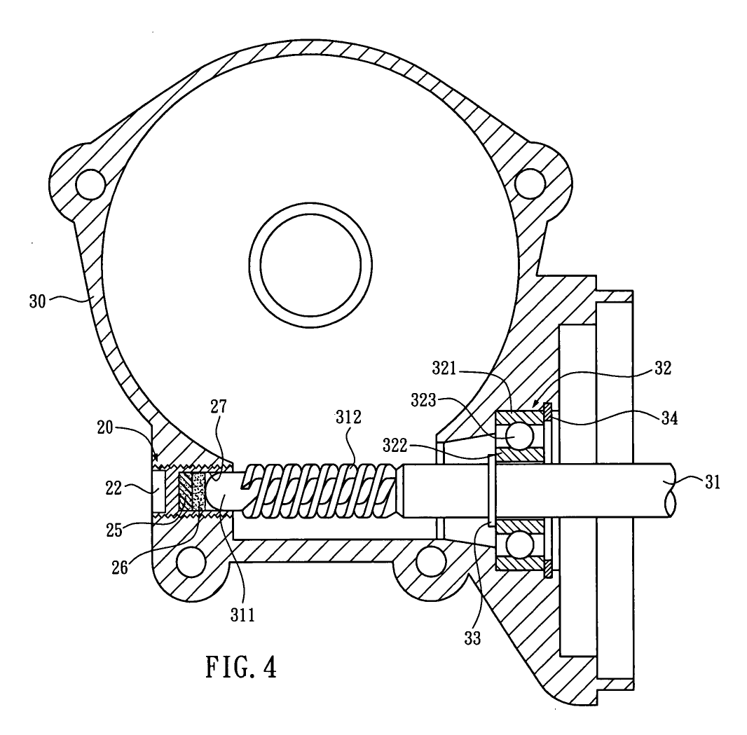

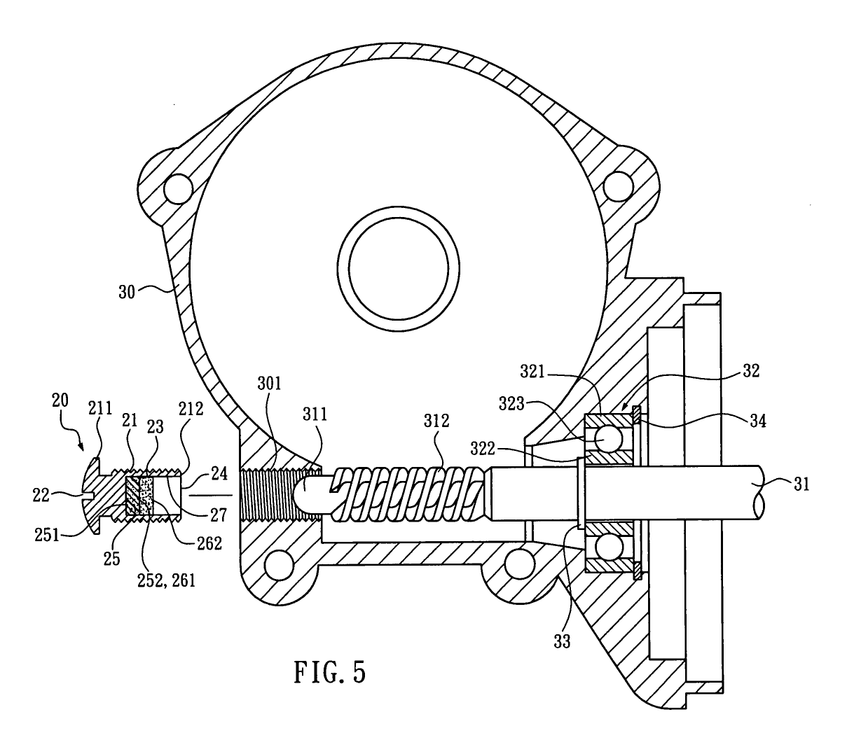

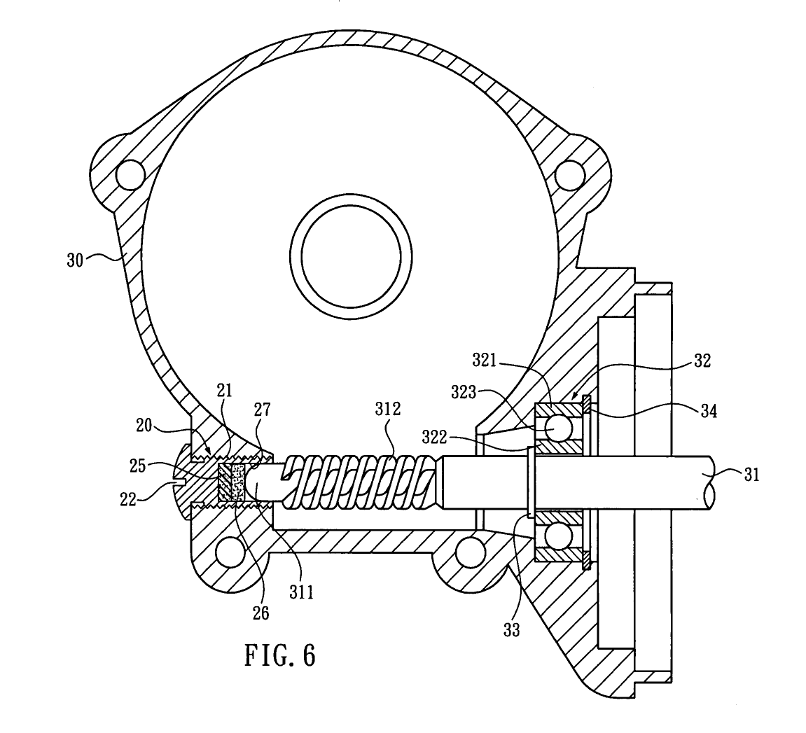

As shown in FIGS. 3 and 4, the main body 21 is realized by a set screw. Alternatively, as shown in FIGS. 5 and 6, the main body 21 is realized by a raised head screw.

The bearing preload mechanism 20 is then combined with a threaded hole 301 preformed on a motor housing 30. A user may use a hand tool to drive the operational portion 22 of the main body 21 so as to screw the bearing preload mechanism 20 into the threaded hole 301. As can be seen in the drawings, the motor housing 30 encloses a motor shaft 31, a bearing 32 settled between the motor housing 30 and the motor shaft 31, a packing 33 arranged on the motor shaft 31 and a positioning ring 34 settled in the motor housing 30. The bearing 32 has an outer ring 321 connected with the motor housing 30, an inner ring 322 connected with the motor shaft 31 and a plurality of balls 323 settled between the inner ring 322 and the outer ring 321. The packing 33 presses against the inner ring 322 of the bearing 32 and the positioning ring 34 abuts the outer ring 321 of the bearing 32.

After the bearing preload mechanism 20 has the opening 24 facing a shaft end 311 of the motor shaft 31 and then has the main body 21 screwed to the threaded hole 301, the shaft end 311 of the motor shaft 31 pierces into the axial hole 23 through the opening 24 while an outer periphery of the shaft end 311 contacts the supporting portion 27. As a result, the motor shaft 31 is supported by the bearing preload mechanism 20 and enabled to withstand a lateral pressure to a predetermined extent. As mentioned herewith, the lateral pressure is referred to a lateral pressure produced as a worm 312 of the motor shaft 31 is combined and operates with a worm gear.

The motor shaft 31 pushes a second end 262 of the connecting pad 26 that in turn pushes the resilient pad 25 so that the resilience of the resilient pad 25 acts on the motor shaft 31 to make the packing 33 push the inner ring 322 of the bearing 32 along the motor shaft 31, thereby forcing the bearing 32 to press against the positioning ring 34 and then making the positioning ring 34 press against the outer ring 321 of the bearing 32, resulting in eliminating internal clearance among the inner ring 322, the outer ring 321 and the balls 323 of the bearing 32.

Although the particular embodiment of the invention has been described in detail for purposes of illustration, it will be understood by one of ordinary skill in the art that numerous variations will be possible to the disclosed embodiments without going outside the scope of the invention as disclosed in the claims.

What is claimed is:

1. A motor bearing preload mechanism, comprising:
a main body, having a first end and a second end opposite mutually along an axis of the main body, and settled in a motor housing wherein the second end corresponds to a shaft end of a motor shaft in the motor housing;
an axial hole, preformed inside the main body and leading to the second end of the main body so as to provide an opening at the second end of the main body;
a resilient pad settled in the axial hole, the resilient pad having a first end abutting an extreme of the axial hole; and
a connecting pad, having a first end abutting a second end of the resilient pad so that the shaft end of the motor shaft presses against the connecting pad and receives a resilience from the resilient pad.

2. The motor bearing preload mechanism of claim 1, wherein the main body is formed with external threads.

3. The motor bearing preload mechanism of claim 2, wherein the main body is a set screw.

4. The motor bearing preload mechanism of claim 2, wherein the main body is a raised head screw.

5. The motor bearing preload mechanism of claim 2, further comprising an operational portion formed at the first end of the main body.

6. The motor bearing preload mechanism of claim 1, further comprising a supporting portion provided in the main body for supporting the shaft end of the motor shaft.

7. The motor bearing preload mechanism of claim 6, wherein the supporting portion is formed from a lateral periphery of the axial hole in the main body adjacent to the second end of the main body.

8. The motor bearing preload mechanism of claim 1, wherein the connecting pad has a surface made of a wear-resistant material.

9. The motor bearing preload mechanism of claim 1, wherein the resilient pad is a pad made of rubber.
